(19) United States
(12) Patent Application Publication
(10) Pub. No.: US 2004/0237724 A1
(43) Pub. Date: Dec. 2, 2004

(54) Bottle and jar lid opener and method

(76) Inventor: Bobby Cope, Georgetown, DE (US)

Correspondence Address: Anderson & Morishita, L.L.C., Suite 102, 2725 Jones Blvd., Las Vegas, NV, 89146, US

(21) Appl. No.: 10/879,910

(22) Filed: Jun. 28, 2004

Related U.S. Application Data
(63) Continuation-in-part of application No. 08/567,283, filed on Dec. 5, 1995, now abandoned.

(51) Int. Cl. B67B 7/46

(52) U.S. Cl. 81/3.32; 81/3.39

(57) ABSTRACT

A bottle and jar lid opener suitable for single hand operation. The opener includes a jar gripping assembly to restrain the jar which has a band tightened by lengthening or shortening the band to engage the band about the body to secure the jar to said band support and base. A wrench also includes a band of material forming a loop tightened about the lid. Rotation of the wrench tightens the band. Any movement of the jar in response to torque applied to the lid for opening thereof causes the jar to roll along a support leading surface to further tighten the band.

### RELATED APPLICATION DATA

This application is a continuation-in-part application of U.S. patent application Ser. No. 08/567,283 filed by Applicant herein on Dec. 5, 1995 and titled “Bottle and Jar Lid Opener.”

### FIELD OF THE INVENTION

The present invention generally relates to devices that facilitate opening of screw-type lids from bottles, jars, jugs and other containers. More specifically the present invention relates to a bottle and jar opener suitable for removing lids using one hand.

### BACKGROUND OF THE INVENTION

Various bottle and jar lid openers have been disclosed in the prior art. The prior art devices generally attempt to replicate the lid gripping and twisting motions involved in manual removal of a secured lid. Some devices known in the art also provide means to increase the torque by increasing the lever arm of the opener. Examples of openers are U.S. Pat. No. 715,226 issued Dec. 16, 1902 where a band is secured about the jar using a lever arrangement and a band wrench is disposed about the lid. The jar is placed on a platform secured by what appears to be fasteners, the platform supporting the jar banding mechanism. Smith, U.S. Pat. No. 951,203 issued Mar. 8, 1910 shows another jar opener where the jar is banded and an adjustable band wrench is disposed about the lid.

Other exemplary bottle and jar lid openers that require the jar to be held by one hand while the lid is manipulated are disclosed in the following U.S. Pat. No.: 2,698,549 to Campbell, U.S. Pat. No. 2,710,551 to Walters, U.S. Pat. No. 2,719,444 to Zeller, U.S. Pat. No. 2,749,748 to Hrebricek, U.S. Pat. No. 3,343,432 to Nagy, U.S. Pat. No. 3,453,911 to Carter, U.S. Pat. No. 3,604,289 to Steel, U.S. Pat. No. 3,724,296 to Craver, U.S. Pat. No. 3,822,614 to Kovacevic, U.S. Pat. No. 4,033,205 to Hoskins, U.S. Pat. No. 4,052,917 to Gee, U.S. Pat. No. 4,306,470 to Woloszyn, U.S. Pat. No. 4,765,207 to Yu, U.S. Pat. No. 4,932,544 to Glazer, U.S. Pat. No. 4,949,576 to Floyd, U.S. Pat. No. 4,995,295 to Floyd, U.S. Pat. No. 5,031,485 to Wu, U.S. Pat. No. 5,083,482 to Floyd and U.S. Pat. No. 5,253,552 to Brand et al.

In Weisband, U.S. Pat. No. 5,313,857 a rather elaborate bottle and jar lid opener is disclosed which includes jar and lid gripping means. U.S. Pat. No. 5,209,142 to Dickson also recognizes the problem of securing the body of a bottle or jar for removal; of a lid by a disabled or weak-handed person. The Dickson invention discloses a bottle or jar gripping device, which retains the body of the bottle or jar in a stationary position by exerting body pressure against the device which, in turn, engages the bottle or jar. Thereby both hands are free to remove the lid from the bottle or jar.

Persons who need or desire a tool to facilitate the opening of bottle or jar lids are generally persons who have arm, hand or wrist limitations. The structural and operational complexity of the prior art bottle or jar openers has limited their commercial acceptability. As previously mentioned, tightly secured lids tend to cause the body of the jar or bottle to rotate when an attempt is made to remove the lid. This problem, which has been generally overlooked by the prior art, it is particularly troublesome for disabled persons who cannot restrain the jar or bottle and simultaneously rotate the lid for removal, such as persons with a single, usable arm or hand. Many prior art devices, such as Weisband, assume that the persons can use one hand to restrain the bottle or jar and the other hand will be used to remove the lid. For other devices, it is assumed that the device will be permanently secured to a fixed substrate such as a wall or counter as suggested in Harrington discussed above.

Thus, it should be understood that there is a need for a device and method which enables a disabled person to remove a screw lid from a bottle or jar, which enables a person with a single usable hand or arm to remove a lid, which does not require permanent mounting to a kitchen counter or wall, which is portable and which is simple and easy to use.

### SUMMARY OF THE INVENTION

There is, therefore, set forth according to the present invention a bottle and jar opener which is simple, easy to use, is portable and is usable by disabled persons, even those with a single usable arm or hand.

According there is set forth a one handed opener for removing the lid from a jar, which includes a base adapted to rest on a flat surface. A band support up stands from the base, the band support having a surface to engage the side of ajar. The surface may be arcuate. A flexible jar band has one end secured to the band support and extends around the body of the bottle or jar and has the other end passing though a slot defined through the band support. The jar bands other end is received through a slot in the jar band support. When jar band slides in the slot in jar band support, it causes the jar band to fit about the jar or bottle to secure jar or bottle to the base. Means are provided for imposing suction between the base and a flat surface, such as a counter top, to secure the base against movement.

Also provided is a jar top wrench including a lid band adjustably disposed on the wrench to be wrapped about the lid. The wrench includes a nose disposed to trap the lid band against the lid to forcibly grip the same as the wrench is moved to unscrew the lid.

Accordingly, the device and method of the present invention may be used by a handicapped person to remove the lid from a bottle or jar.

Further the device may be used by anyone for the same purpose. The device is adjustable, of simple construction and use.

### BRIEF DESCRIPTION OF THE DRAWINGS

These and other features and advantages will become appreciated, as the same becomes better understood with reference to the specification, claims and drawings wherein:

FIG. 1 is a three dimensional perspective view of the bottle and jar lid opener according to the present invention;

FIG. 2 is a top view of a jar being placed on the base within a jar band, formed as a loop of the present invention;

FIG. 3 is a top perspective view of a jar secured on the base by the jar band, formed as a loop to the present invention;

FIG. 4 is a cross-section view of the assembled platform of FIG. 3 to the present invention;

FIG. 5 is showing the rubber membrane with two metal inserts of the present invention;

FIG. 6 is a cross-section view of one of the chambers, with one of the metal inserts exposed to present invention;

FIG. 7 is a plan side view of the lid wrench;

FIG. 8 is a top plan view of the lid wrench with an exploded view of a lid band guide button;

FIG. 9 is a three dimensional breakdown of lid wrench;

FIG. 10 is an end nose view of the wrench nose;

FIG. 11 is a view of the backside of the wrench nose; and

FIG. 12 is a side view of metal insert and to left is a top view of metal insert.

### DESCRIPTION

In the following description of the invention, the term “jar” should be understood to include bottles or other containers having a lid or plug which is threadably secured to the jar to define a closure therefor. “Lid” should be understood to not only embrace a lid but threaded tops and plugs as well.

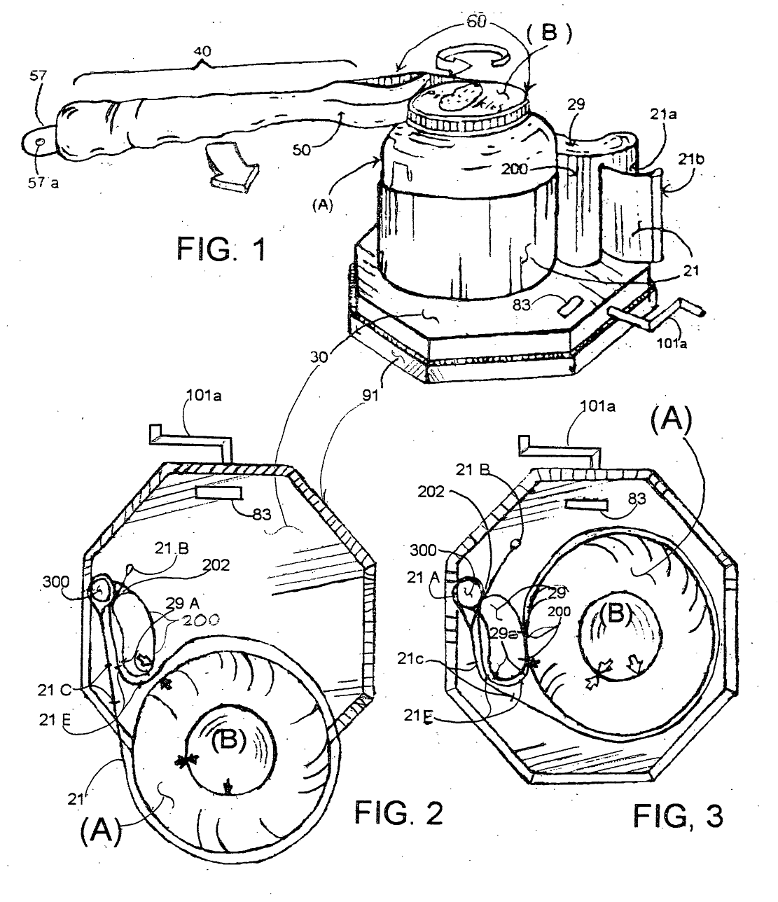

FIG. 1 illustrates a jar opener 1 according to the present invention shown coupled to a jar “A” having a removable, twist off lid “B”. Opener 1 provides means to sufficiently loosen the lid B so that the lid B can thereafter be easily removed by hand.

The opener 1 includes a jar band support 29 and a gripping lid wrench 40 adapted to grip the lid B for rotation thereof. The support 29, as shown in FIG. 1, is adapted to restrain the jar A to a fixed substrate such as counter top (not shown) so that the lid B may be loosened by one hand using the wrench 40 and, if desired, removed.

To restrain the jar A to the assembly, a jar band support 29 has a flexible jar band 21 and a base platform 30. The wrench 40 includes a rigid wrench arm 50 and a flexible lid band 60.

To secure jar A against jar band support 29, the jar band 21 has a first end 21a formed as a loop about a post 300 secured to and upstanding from the base platform 30. Opposite the first end 21a, the jar band 21 has a free second end 21b. The band 21 is formed into a loop 21 disposed above the platform 30 (FIGS. 2 and 3) and is adapted to go around the jar A. The loop 21 can be adjusted to fit the size of a jar A by pulling second end 21b to proper size. The second end passes through a slot 202 defined between the post 300 and band support 29 as shown in FIGS. 2-3. By pulling on the second end 21b the jar band loop 21 can be fitted about the jar A. The loop 21 should be left loose enough to rotate jar A along a leading edge 200 of the band support to center of base plate 30. As shown, the leading edge tapers or diverges away from the jar A such that rotation of the jar A along the leading edge 200 in response to the imposition of torque, tightens the jar band. When this is accomplished, jar A rotates against the jar band support 29 which secures it against jar band support leading edge 200 (FIGS. 2-3). When this takes the band loop 21c is pulled against the jar band 21e and then pulled against jar band support 29a and secures the jar band 21 from slipping around the jar A (FIGS. 2 and 3) and to secure the jar A to the band support 29.

As can be seen in FIG. 2, to fix the platform 30 of the FIG. 1 to a substrate such as a counter top, a plurality of platform suction cups 91 are disposed on the bottom surface 30a of the base platform 30. To secure the base platform 30 to a flat surface, suction cups 91 are preferably wetted before pressing the base platform 30 onto the flat surface.

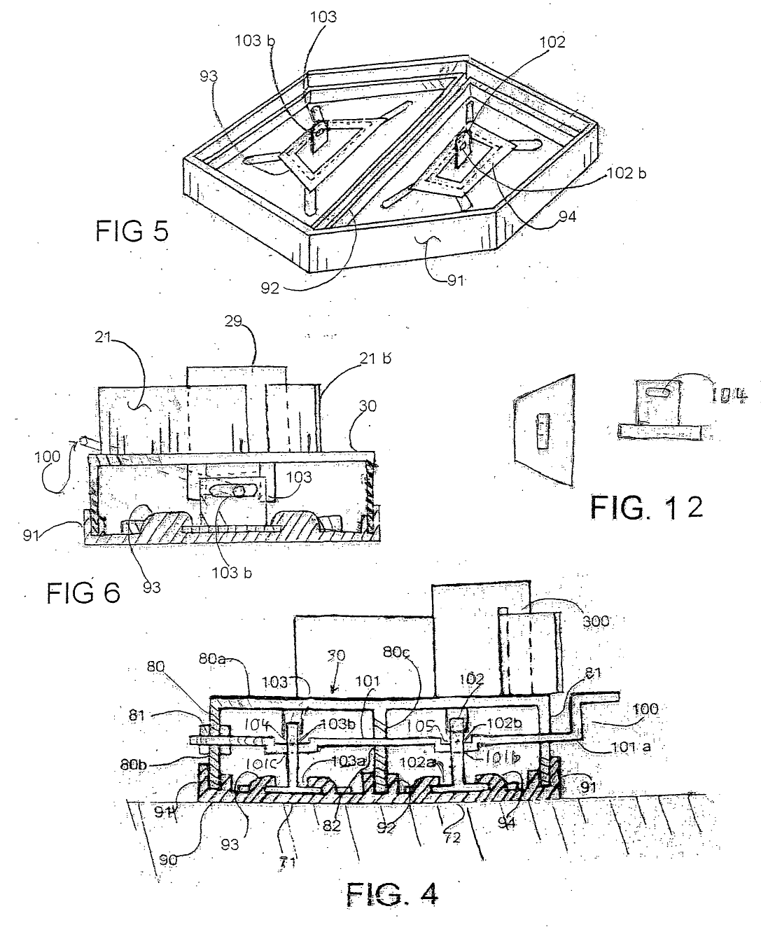

FIGS. 6 and 4 illustrate a second embodiment of a base platform 30 for the FIG. 1. Base platform 30 has a polygonal shape and generally includes a platform support portion 80, a platform suction portion 90 and a suction lever assembly 100. Platform support portion 80 is substantially a cover for the base platform 30 that is receivable in the platform suction portion 90. A vacuum is formed between the platform support portion 80 and the platform suction portion 90.

As can best be seen in FIG. 4, platform support 80 includes a flat top wall 80a, and a downwardly extending central wall 80c. Suction lever assembly 100 rotatably engages opposing orifices 81 formed in the peripheral edge 80b and a central orifice 82 formed in the central wall 80c of platform support portion 80. Suction lever assembly 100 interacts with the platform suction portion 90 as hereinafter described to secure the base platform 30 to a flat substrate surface such as a counter top.

As shown in FIGS. 6 and 4 platform suction portion 90 includes a peripheral slotted arm 91 and a central slotted arm 92 which respectfully receive the peripheral edge 80b and central wall 80c of platform support portion 80 (FIG. 4). When platform support portion 80 and platform suction portion 90 are engaged the central wall 80c of the platform support portion 80 divided the interior of the second base platform 30 into respective first and second vacuum chambers 71, 72. Platform suction portion 90 is preferably formed from molded rubber or other elastic material. First and second flexible bearing plates 93, 94 are centrally disposed on a top portion of the platform. suction portion 90 in the respective first and second vacuum chambers 71, 72. The vacuum formed in the respective vacuum chambers 71, 72 of the base platform 30 causes the platform suction portion 90 to have an upwardly curving contour.

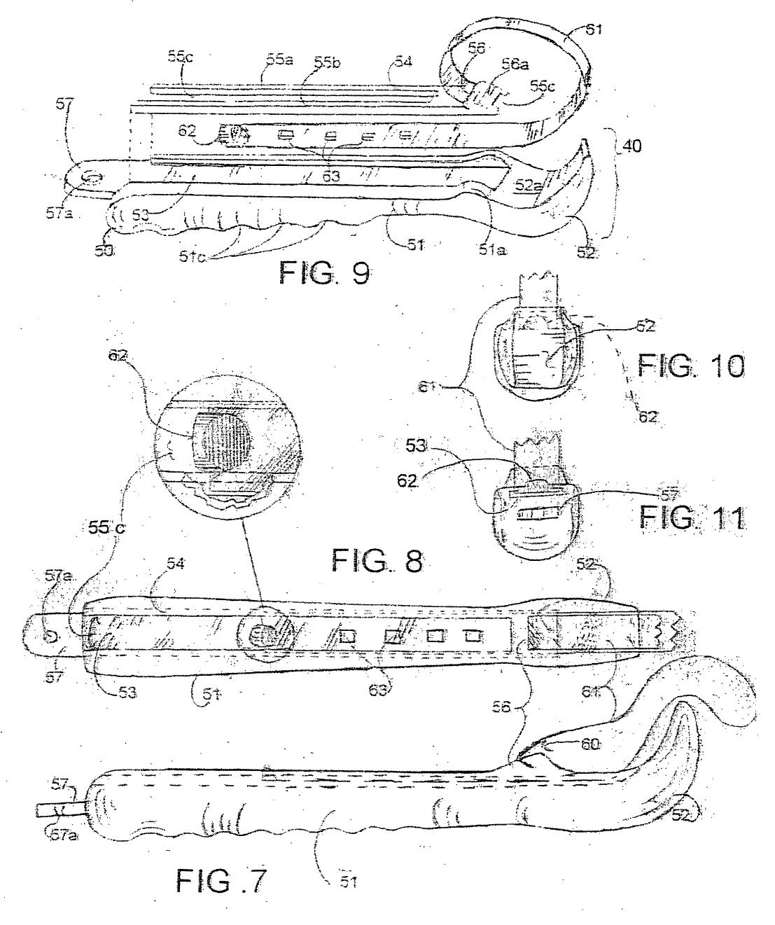

Operation of the suction lever assembly 100 selectively depresses and releases first and second bearing plates 93, 94 to thereby adhere platform suction portion 90 to a flat surface such as a counter top. Suction lever assembly 100 includes an extended rod 101 having a crank handle 101a formed at one end of rod 101 and disposed to an outward side of the base platform 81. Suction lever assembly 100 further includes respective first and second lever support dogs 101b, 101c which align with the respective bearing plates 93, 94 of the platform suction portion 90. First and second bearing arms 102, 103 are attached to the respective first and second lever support dogs 101b, 101c or the rod 101. First and second bearing arms 102, 103 include respective first and second pressure plates 102a, 103a and first and second pressure plate lever supports 102b, 103b that extend vertically upward from the respective first and second pressure plates 102a and 103a. First and second lever supports 102b, 103b include respective first and second elongated slots 104, 105 (FIGS. 4-12) for receipt of the first and second lever support dogs 10lb, 101c. Crank handle portion 101a is rotated in a first direction to move the respective pressure plates 102a, 103a upwardly to engage the flexible bearing plates 93, 94 of the platform suction 90 and thereby secure base platform 30 to the flat surface. Crank handle portion 101a is rotated in the opposite direction to release the bearing plates 93, 94 and thereby release the platform suction portion 90 to return to its normal position. Utilizing the suction lever assembly 100, the base platform 30 can be readily secured to a flat surface by a single hand with little physical effort. Thereby, in combination with the jar band support 29 and jar band 21, the jar A can be restrained against rotation.

To loosen the lid B that is moderately secured to ajar A, the base platform 30 is first secured to a flat surface such as a counter top. The jar A is placed on the platform 30 and the jar band 21 is extended about the jar A and its end 21b is threaded through the band support 29 slot 202. Thus, a person with a single arm or hand may secure and restrain the jar A to the substrate such as a counter top for loosening the lid B. With a single hand the lid B may be loosened. However, where the lid B is tightly secured to jar A, the lever wrench 40 may be used to loosen the lid B for removal.

FIG. 1 illustrates a lever wrench according to the present invention. The lever wrench 40 includes a wrench arm 50 and a flexible lid band 60. Wrench 50 includes an elongated wrench handle 51 having an arcuate nose 52 disposed at one end. The inner wall 52a of the wrench nose 52 is concave and extends from a distal end of the wrench nose 52 to wrench handle 51a. A lid band slot 53 extends longitudinally along the handle 51 from the end of the handle 51 and through the rise 51a. Lid band slot 53 receives the lid band 60 in sliding engagement as hereinafter described.

A lid band guide 54 is receivable within the lid band slot 53 to extend over the lid band 60. Lid band guide 54 is substantially a two-pronged fork having paired, parallel prongs 55a, 55b formed at the proximal end of the lid band guide 54 and lid band head 56 formed at the distal end of the band guide 54. a guide slot 55c is formed between the respective parallel prongs 55a, 55b and extends through the lid band head 56. Lid band head 56 is formed having a rearwardly angled head extension 56a. Lid band 61 is fixedly attached at one end thereof the head extension 56a. The width of the guide slot 55c is slightly larger than the width of the lid band 61 to retain the lid band within the handle 51 (FIG.9). Handle 51 includes a plurality of finger recesses 51c formed in an outer wall 51b of the handle 51 to facilitate manual grasping. Handle 51 further includes a stem 57 having a stem orifice 57a formed therein for hanging storage of the lever wrench 40. Lever wrench 40 may alternatively be stored by inserting the stem 57 in a wrench storage slot 83 formed in the platform support portion 80 of the platform 30 (FIG.1).

Referring again to FIG. 1 it can be seen that the lid band 60 is substantially a flexible strip of material 61 that extends from the head extension 56a through the guide 53 form a closed loop. A lid band guide button 62 is disposed at the free end of the strip of material 61 to facilitate adjustment of the size of the closed loop formed by the strip of material 61. A plurality of raised band protrusions 63 are disposed along the strip of material 61 to facilitate the adjustment of the lid band 60 using a single hand. By using the thumb to engage the button 62 or protrusions 63 the lid band material 61 may be slid though the slot 53 to expand and contract the loop.

Reference is now made to FIG. 1 which illustrates the engagement and operation of lever wrench 40 on the lid B. The closed loop formed by the strip of material 61 is first disposed about the lid B. The loop is tightened about the lid B as described above. As shown by the phantom line, the handle 51 is manipulated in a counterclockwise direction first causing the nose 52 to engage the side of the jar A and band 61. Further rotation of the handle 51 causes the nose 52 to pivot against the side of the jar A and taking up any remaining looseness in the band to further tighten the band 61 about the lid B. Continued rotation the handle imparts torque to the lid B for loosening thereof. It should be noted that the imparted torque may tend to rotate the jar A instead of loosening the lid B. Such torque, if the jar A is not completely restrained, causes the jar A to roll along the band support leading edge 200 further tightening the jar band 21 about the jar A.

After the lid B has been loosened the handle 51 is reversely rotated in a clockwise motion. Then the lid may be removed by a single hand. The jar A may also be released in the manner described above.

While I have shown and described certain embodiments in the present invention, it should be understood that the invention is subject to many modifications and changes without departing from the spirit and scope of the present invention. For example the leading surface 200 and/or nose 52 need not be arcuate but can be flat.

I claim:

1. A one handed opener for removing the lid from a jar comprising:
a base adapted to rest on a flat surface, a band support upstanding from the base, said band support having a arcuate to support the side of a jar and a slot;
a jar band having one end secured to the and support, said jar band adjustably disposed about and conforming to the contours of the outside of the jar and having the other end passing through the slot, said jar band positioned such that torque applied to said jar urges the jar to engage and roll along said leading surface to tighten said jar band and affix said jar to said band support;
means for securing said base to said flat surface;
a jar lid wrench including a lid band adjustably disposed on the wrench to be wrapped about the lid, said wrench including a nose disposed to trap said lid band against the lid as the wrench is moved to tighten said band, impose torque to said jar to affix the jar to said support and unscrew the lid.

2. The opener of claim 1 wherein said securing means comprises imposing a suction coupling between said base and the flat surface.

3. The opener of claim 2 comprising said suction coupling includes a flexible membrane on said base and a lever assembly connected to said membrane to move the membrane to impose a suction between said base and said flat surface.

4. The opener of claim 1 comprising said nose is arcuate.

5. A method for loosening a lid from ajar comprising:
releasably mounting a platform to a supporting substrate, said platform including a band support with a leading surface and a slot;
placing the jar on the platform and positioning a jar band about the jar, the jar band fixed on one end and the other passing through the slot;
adjusting a band of a lid wrench to the jar lid and rotating the wrench, the wrench including a nose disposed to trap said lid band against the lid as the wrench is moved to tighten said band about the lid and impose torque to said jar to move said jar along the leading edge to tighten the jar band and affix the jar to said support and further rotation of the wrench unscrewing the lid.
